(19) United States
(12) Patent Application Publication
(10) Pub. No.: US 2010/0132108 A1
(43) Pub. Date: Jun. 3, 2010

(54) Pre-fabricated device for creating a vanishing edge effect and process for creating the same

(76) Inventor: Weyand Helmut Rudi, San Diego, CA (US)

Correspondence Address: HARRY V. MCGAHEY JR., 1532 SIXTH AVENUE, SAN DIEGO, CA, 92101, US

(21) Appl. No.: 12/476,187

(22) Filed: Jun. 1, 2009

Related U.S. Application Data
(60) Provisional application No. 61/129,034, filed on Jun. 2, 2008.

(51) Int. Cl. E04H 4/00; B23P 17/04

(52) U.S. Cl. 4/509; 29/428

(57) ABSTRACT

A device for building a vanishing edge pool utilizing a prefabricated trough anchored to the exterior side of the weir wall of the pool so as to catch the overflow of the pool as it pours over the lower wall. A preferred embodiment utilizes a full cap to cover the entire thickness of the exterior wall and a vertical lip to help anchor the trough onto the exterior wall which is lower than the specified level of water in the pool

### CROSS REFERENCE TO RELATED APPLICATIONS

This application claims priority from provisional application Ser. No. 61/129,034, filed on Jun. 2, 2008.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of creating vanishing edge effects and more specifically to a pre-fabricated or pre-assembled trough apparatus for creating a vanishing edge effect pool and a process for creating the same. It provides a device and an alternative means for catching and moving water as it spills over a “disappearing edge”/“vanishing edge” pool. It is a device providing a novel pool wall feature, as well as a device creating the “disappearing edge” feature itself. This pre-fabricated device that collects and channels the water away can be whatever form of container the contractor or client wishes.

“Vanishing edge”, also known as “infinity edge”, “negative edge”, “disappearing edge” or “zero edge” pools have been known for some time. However the construction of these pools has until now always been extremely complicated and expensive because the pool wall edge which is lower than the rest of the pool (the “weir”), which creates the effect of there being no side to the pool, has to be specially constructed as an integral part of the pool itself. This requires extensive planning, design and construction work.

A typical negative edge feature is built as part of and at the same time as the pool itself. Concrete is shot via a pump into and around a hand built rebar mesh, then finished to make the necessary walls and shapes to satisfy the desired design and function. This is a very messy and laborious task. With this pre-fabricated device the dirty and laborious task of steel and concrete construction of the catch basin is replaced with a device that is easily attached and/or installed.

The typical vanishing edge weir wall is constructed several inches below the other pool walls, slightly above (approximately ½″) the projected normal water line which will exist when the negative edge system pump is turned off. (A portion of the over all length of the pool wall is cut/shaped slightly lower than the normal edge of the bond beam. This is the “weir” wall.) It is over this lower weir wall that the water will flow in order to create the effect. When the negative edge system pump is turned on, additional water is forced into the pool causing the water to rise to a point that the water line rises above the level of this lowest portion of the pool (the weir wall), which then creates the vanishing “edge” effect. As the water overflows it typically flows down a slight decline in the top of the weir wall that leads to the outside of the pool. However the portion of the weir wall meant to be the “disappearing edge” or “negative edge” can be shaped flat, rounded or angled. In a traditionally built pool, a concrete and mesh basin is constructed to catch the runoff.

Typically these types of pools have two water circulation systems. The first is for filtering and heating the water in the main pool. The second circulation system known as the “edge system” or “effect system” filters the water in the catch basin and returns it to the upper pool. When the edge-system stops, the water level in the upper pool continues to spill into the basin stopping at the level of the weir wall. The water necessary to raise the upper pool and fill the edge system plumbing is called the “water in transit”.

A secondary purpose of the prefabricated troughs and basins are to catch any spill-over by bathers in the pool while at rest or play. (Since the water is only slightly below the lowest part of the pool wall intended to be the vanishing “edge”.)

Various innovations have been developed which are related to various aspects of pool construction:

U.S. Pat. No. 7,194,774-B2 to Bergstrom describes a filter cover with lighting.
U.S. Pat. No. 6,443,654-B1 to Kauppi discloses an energy dissipating spillway.
U.S. Pat. No. 6,409,917-B1 to Malone, Jr. describes a return Port for a swimming pool filter.
U.S. Pat. No. 6,375,342-B1 to Koren et. al shows an illuminated waterfall.
U.S. Pat. No. 4,238,859 to Badon, Sterling P. discloses a spill-over spa.
U.S. Pat. No. 6,360,380-B1 to Swart et. al. shows an overflowing soaker bath tub.
U.S. Pat. No. 6,233,754-B1 to Ajima discloses a swimming lap pool.
U.S. Pat. No. 5,720,056 to Aymes shows a swimming pool with a spillway.
U.S. Pat. No. 5,032,038 to Lempleriere describes a spillway for dams.

However none of these inventions discloses or anticipates a system for easily building a vanishing edge pool without having to perform the expensive and time consuming is design and construction now required when building such pools in a conventional steel and concrete manner.

Currently the construction of the “weir” wall, which creates the effect of there being no side to the pool, has to be specially constructed as an integral part of the pool itself. The sides of the pool and the recirculating pipes with current technology must be formed and shaped with the hardware in place. This requires extensive planning, design and construction work. Because of this such style pools tend to be very expensive and require extensive architectural design. The current invention avoids this pour in place technology and allows a vanishing edge pool to be constructed less expensively using pre-fabricated, pre-assembled parts. Specifically a pre-assembled trough system is used which allows easy and fast anchoring to the exterior side of the weir wall, thereby creating a negative edge effect pool much faster and less expensively than any type of process or apparatus now in use today can do. This pre-assembled trough can be made of any strong waterproof material including metal, plastic or glass. The finished trough can also be fitted with low voltage and fiber optical lighting in order to enhance the visual effect.

### BRIEF SUMMARY OF THE INVENTION

The primary object of the invention is to provide a pre-fabricated device for more easily creating a vanishing edge effect on one or more sides of a pool.

Another object of the invention is to provide a less expensive way of constructing a pool with a vanishing edge on one or more sides. Another object of the invention is to provide a faster and less complicated way of constructing a pool with a vanishing edge effect on one or more sides.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a prefabricated device for creating a vanishing edge effect comprising: a prefabricated or pre-assembled trough, an attachment means to anchor the trough to the exterior side of the weir wall of the pool so as to catch the overflow of the pool as it pours over the weir wall during the times when water is pumped into the pool to raise the water level above that which exists when the edge system pump is off, a means of drainage for output from the trough, a reservoir means for collecting the output drainage from the trough, a pumping means for recirculating the drainage from the reservoir means from the trough back into the pool, and an input means to return the recirculated drainage from the reservoir means back into the pool.

In accordance with a preferred embodiment of the invention, there is also disclosed a process for building a vanishing edge pool comprising the steps of: building a pool of water wherein one wall (the weir wall) of the pool is built lower than the level of the water at the specified depth in the pool when the negative edge pump is on, building a pre-assembled and/or prefabricated trough, then utilizing an attachment means to anchor the pre-assembled trough to the exterior side of the weir wall so as to catch the overflow of the pool as it pours over the weir wall once it is installed, installing a means of drainage for output from the trough, installing a reservoir means for collecting the output drainage from the trough, installing a pumping means for recirculating the drainage from the reservoir means from the trough back into the pool, and installing an input means to return the recirculated drainage from the reservoir means back into the pool.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a cross sectional view of the invention.

FIG. 2 is a cross sectional view of the invention with a half cap.

FIG. 3 is a cross sectional view of the invention with a full cap showing a bolt cap anchor and a bolt trough anchor.

FIG. 4 is a cross sectional view of the invention with a full cap and only a bolt cap anchor.

FIG. 5 is a cross sectional view of the invention with a pre-assembled pin anchor.

FIG. 6 is a cross sectional view of the invention wherein the full cap has a vertical lip on the interior of the weir wall.

FIG. 7 is a cross sectional view of the invention with a spout means to direct the overflow of water into a catch basin.

FIG. 8 is a cross sectional view of the invention wherein a notch is poured and/or excavated into the weir wall during construction, a notch trough is installed, and a catch basin is below the first trough.

FIG. 9 is an elevational view of the invention with a notch trough along one side of the weir wall with a catch basin beneath.

FIG. 10 is a cross sectional view of the invention showing an embodiment of a trough comprised of a partial spherical shape.

FIG. 11 is an elevational view of the invention showing one embodiment of a trough with a plurality of drainage means built into the trough.

FIG. 12 shows some typical examples of trough shapes which can be used to embody the invention.

FIG. 13 is a schematic diagram illustrating the operation of a typical recirculation system in the preferred embodiment of the invention.

FIG. 14 is an exploded view of the invention showing a cross-section of an outlet manifold used to anchor a catch basin in place.

FIG. 15 is a perspective view of a typical example of a contoured upper weir wall surface which can be embodied in the invention.

FIG. 16 is a perspective view of a typical example of a contoured upper weir wall cap surface which can be embodied in the invention.

FIG. 17 is a perspective view of two typical examples of upper weir wall surface designs which can be embodied in the invention by embossing or imprinting.

FIG. 18 is a perspective view of an example of a contoured upper weir wall cap surface which can be embodied in the invention.

FIG. 19 is a schematic diagram illustrating the typical placement of an atrium drain in a trough portion of the invention for the purpose of overflow and debris collection.

FIG. 20 through 29 show a number of elevational and aerial views of typical embodiments of pre-assembled troughs which can be used as embodiments of the invention. FIGS. 20, 21, 24, 25, 26, 27, 28 and 29 are aerial views. FIGS. 22 and 23 are elevational views.

FIG. 30 is an elevational view of the invention showing one embodiment of a trough with a pump recirculation system for the edge effect pre-fabricated and pre-installed in the trough itself as part of the pre-assembled trough.

FIG. 31 is a cross sectional view of the invention showing an embodiment of a trough with a pump recirculation system for the edge effect pre-fabricated and pre-installed in the trough itself as part of the pre-assembled trough.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

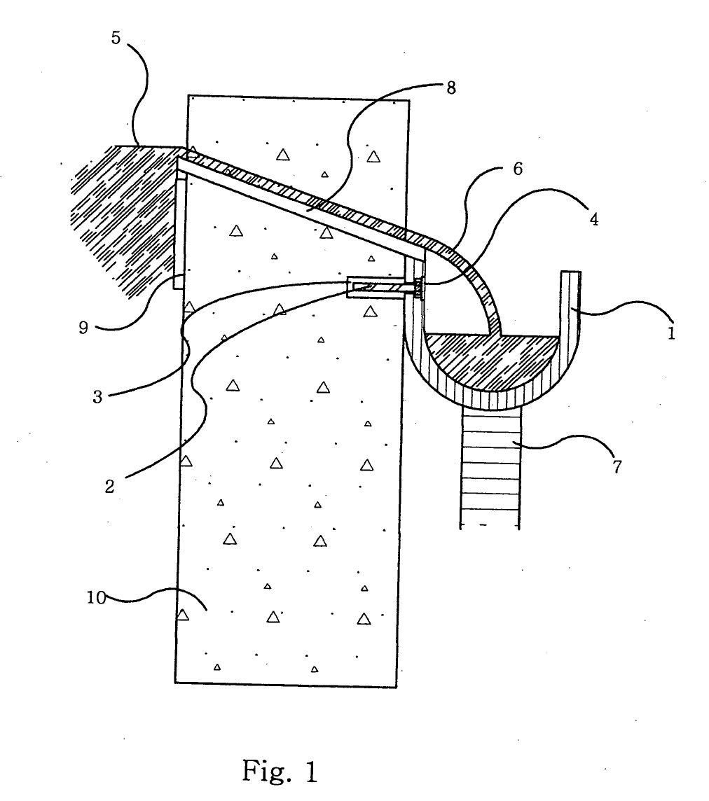

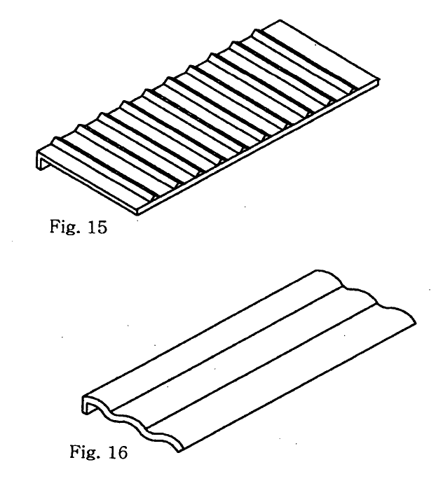

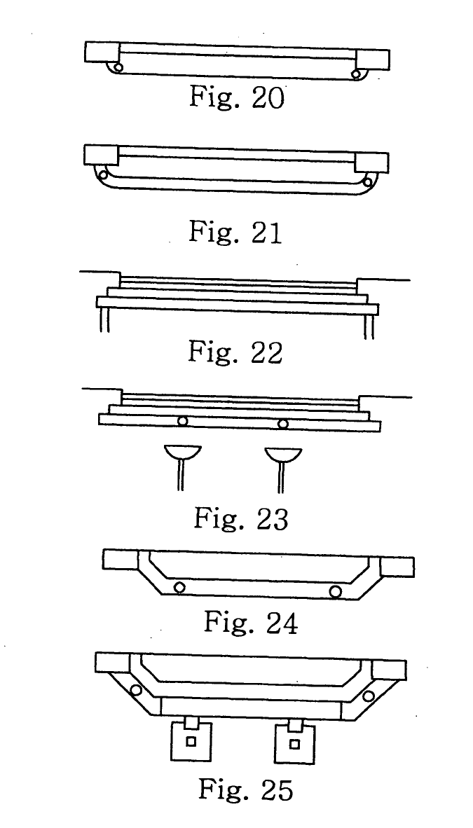

Turning now to the drawings, FIG. 1 is a cross sectional view of the device showing the basic pre-fabricated trough assembly for building a vanishing edge effect pool comprising a number of walls, the pool being designed to hold water at a specified height above the level of the weir wall which will provide the vanishing edge effect. One or more of the weir walls will have a trough (1) which is pre-assembled and then attached to the exterior side of the pool weir wall (10) using an anchoring attachment means (2) placed into a pre-cored opening (3). In the preferred embodiment shown this anchoring attachment means is comprised of a bolt being fitted into the pre-cored opening. This pre-cored opening (3) can also be drilled into the wall after the pool wall is poured. A bolt sealing means (4) to prevent water damage from occurring to the anchor bolt means (2) is also shown. The bolt sealing means can also provide aesthetic relief. The water level (5) passes over the lower part of the top of the weir wall over a cap (8) and the overflow or run off water (6) pours into the trough (1) after which this output from the trough exits the trough (1) by a drainage means (7). This overflow over the side of the pool gives the vanishing edge effect. The drainage means can have an atrium drain placed over the top of it (See FIG. 19), to prevent sediment from clogging the drainage system. The number and placement of atrium drains can also be used to create varying water overflow configurations. There is a reservoir means for collecting the output drainage from the trough or troughs. Also a decorative overflow surface can be installed on top of, or as part of the cap (8)) to give various water effects (See FIGS. 15 through 18). On the inside of the pool there is shown the location of the water line decorative finish (9) which is ordinarily slate, tile or ceramic. The weir wall (10) of the pool is generally composed of shot concrete or gunite in the preferred embodiment, but any type of pool construction capable of anchoring the trough (1) and related components can be used. Although this figure, and the following cross sectional views show only one anchor bolt means (2) and pre-cored opening means (3), in actual use there will always need to be a plurality of anchor means placed horizontally along the trough itself sufficiently to hold the trough (1) onto the weir wall (10). Just one anchor bolt means would not be sufficient to hold a trough in place. Other water proof adhesive means such as epoxy, cement or acrylic can also be used in place of or in conjunction with a bolt means for an anchoring means. Also, it is understood that there can be a plurality of walls lower than the specified level of water in the pool, each having a pre-assembled trough or a plurality of pre-assembled troughs to collect the overflow from the pool. Also a plurality of drainage means can be built into each trough.

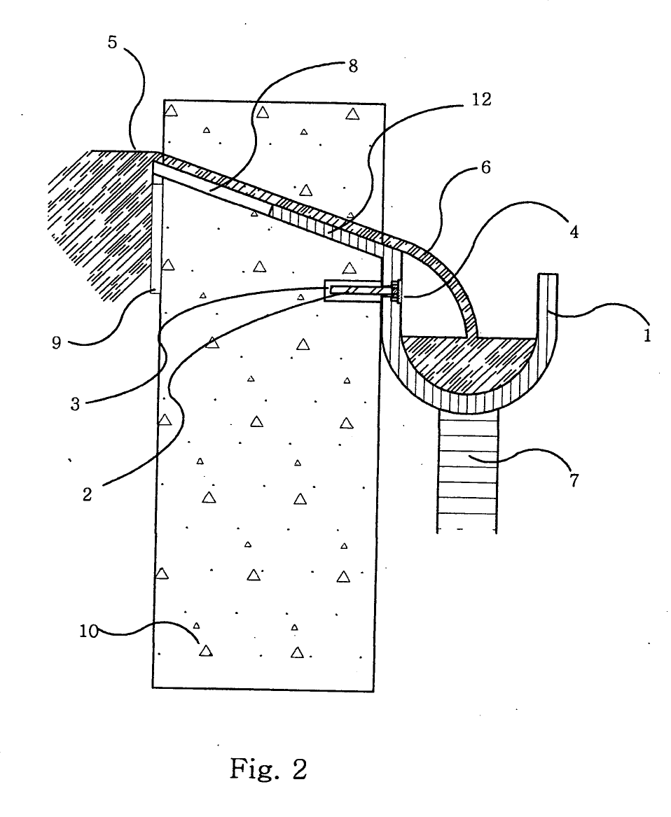

FIG. 2 is a cross sectional view of an embodiment of the invention with a half cap (8). The cap is designed to cover part or all of the top of the thickness of the weir wall which is lower than the specified level of water in the pool (The “weir wall”). The trough (1) in FIG. 2 is pre-assembled with a half cap extension (12) attached directly to the trough which meets the half cap (8) in the center of the weir wall (10). Although the terms “half” and “full” are used to denote the size of the cap, a pre-assembled trough contains, or can contain any size cap, partial cap, or pre-assembled cap so long as the cap's size does not leave a gap on the top of the weir wall (10). A full cap is defined as one which is covering the entire thickness of the weir wall.

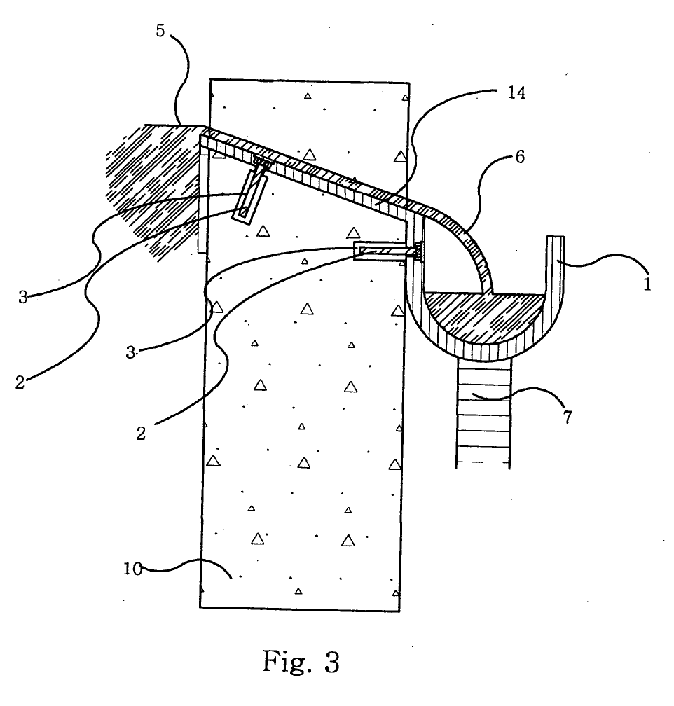

FIG. 3 is a cross sectional view of an embodiment of the invention with a pre-assembled self anchoring full cap extension (14) attached to the trough which has an additional anchor bolt means (2) and pre-cored opening (3) to assist in anchoring the full cap extension (14) in place. In this embodiment, the trough (1) also has an anchor bolt means, an anchor bold means (2) and a pre-cored opening (3) to anchor the trough (1) to the side of the weir wall (10).

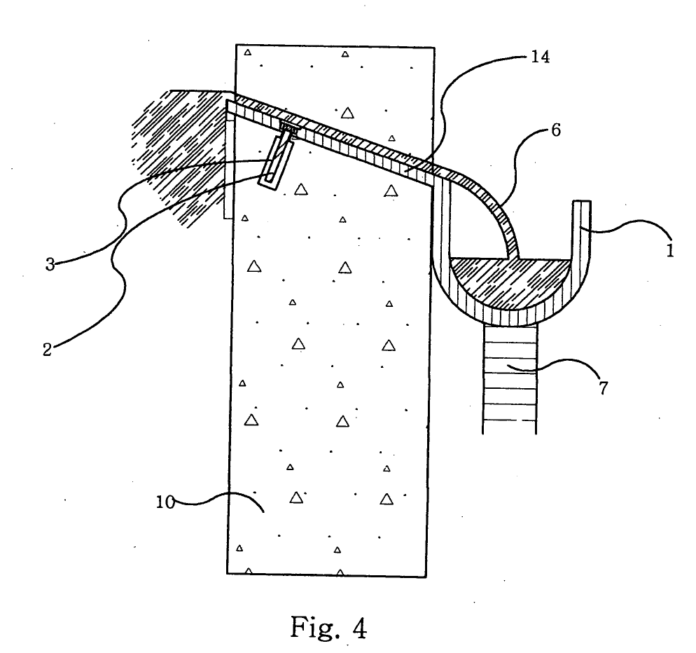

FIG. 4 is a cross sectional view of an embodiment of the invention with a full cap (14) but instead of using an anchor means on the trough itself, only a single anchor bolt means (2) and a pre-cored opening (3) located in the full cap (14) itself are used.

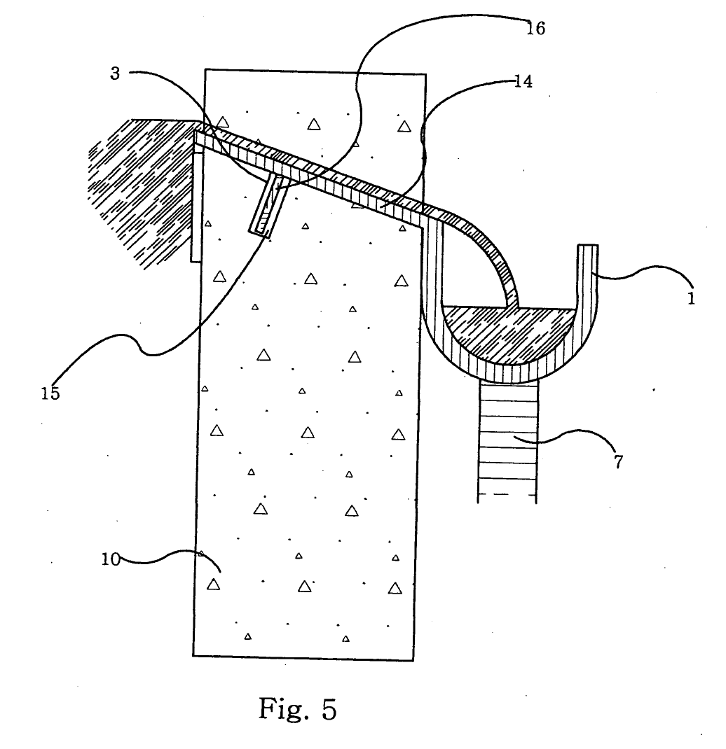

FIG. 5 is a cross sectional view of an embodiment of the invention with a pre-constructed post anchor means (16) pre-attached to the bottom of the pre-assembled full cap (14) itself. This pre-cored opening (3) can be filled with an epoxy or other waterproof bonding agent means (15) to help anchor the pin (16).

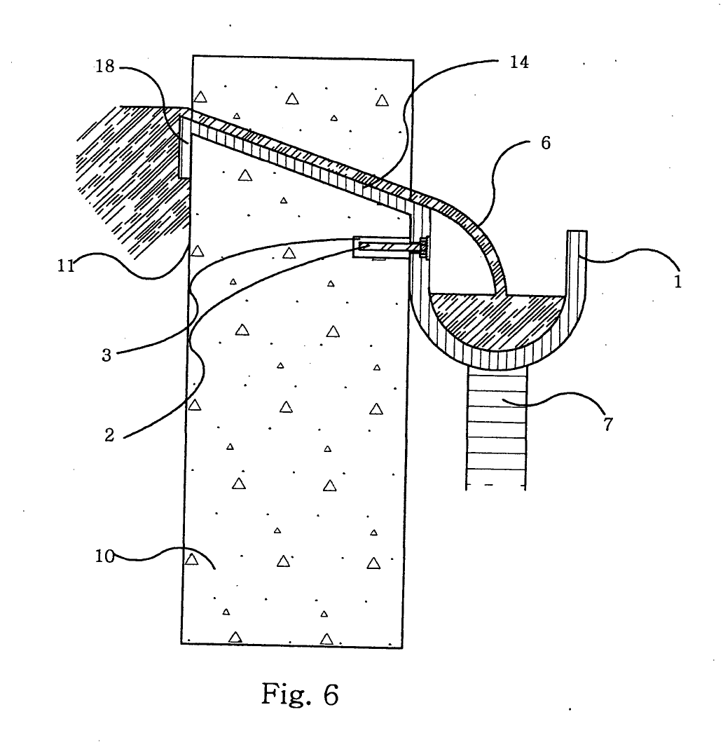

FIG. 6 is a cross sectional view of an embodiment of the invention wherein the full cap has a pre-assembled vertical locking lip (18) on the interior of the weir wall (11) to help anchor the full cap (14).

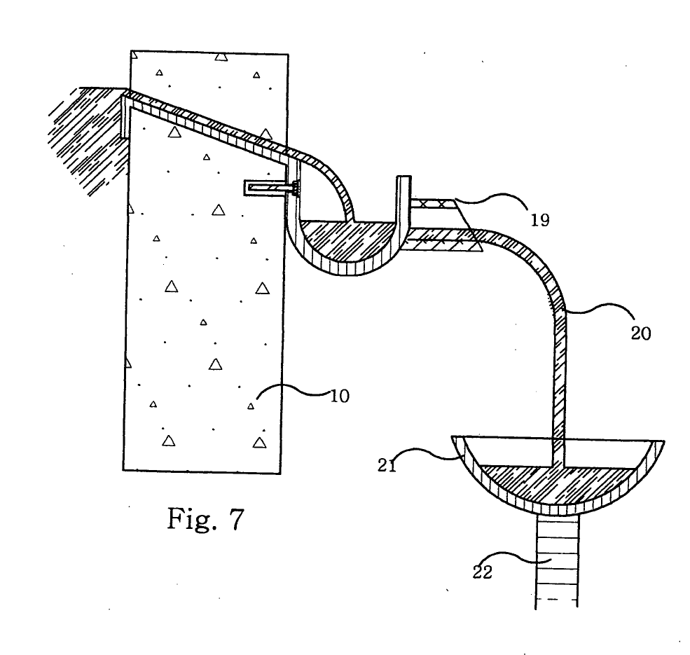

FIG. 7 is a cross sectional view of an embodiment of the invention with a pre-assembled spout means (19) for directing the catch basin overflow (20) of water into a catch basin (21) with a catch basin drainage means (22). The catch basin can be in a to decorative, as well as a purely functional shape for aesthetic purposes.

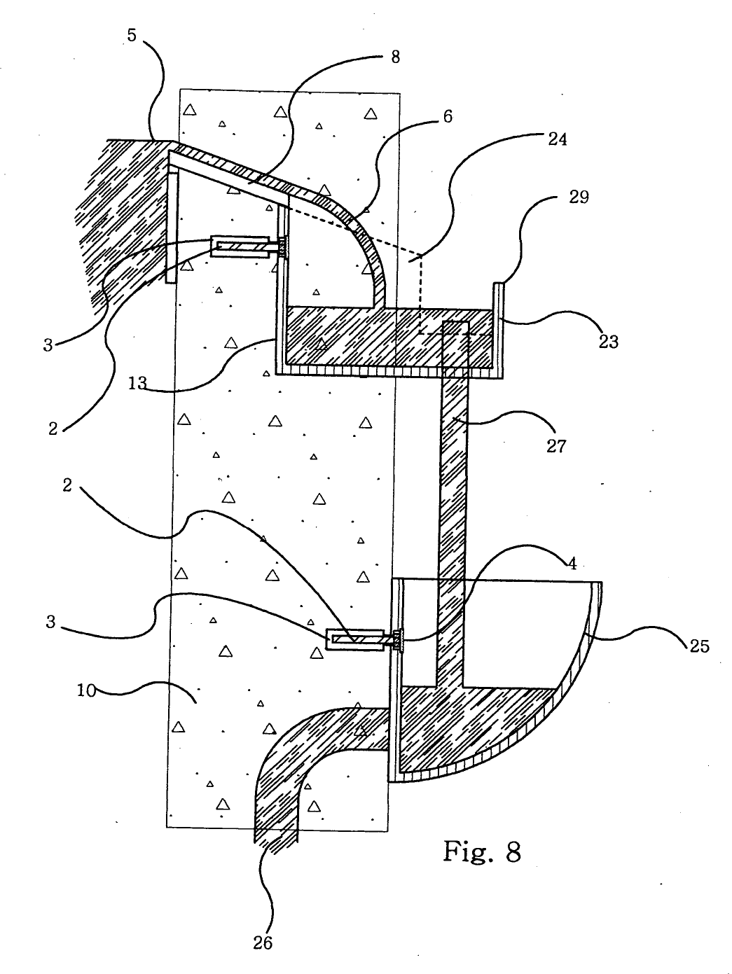

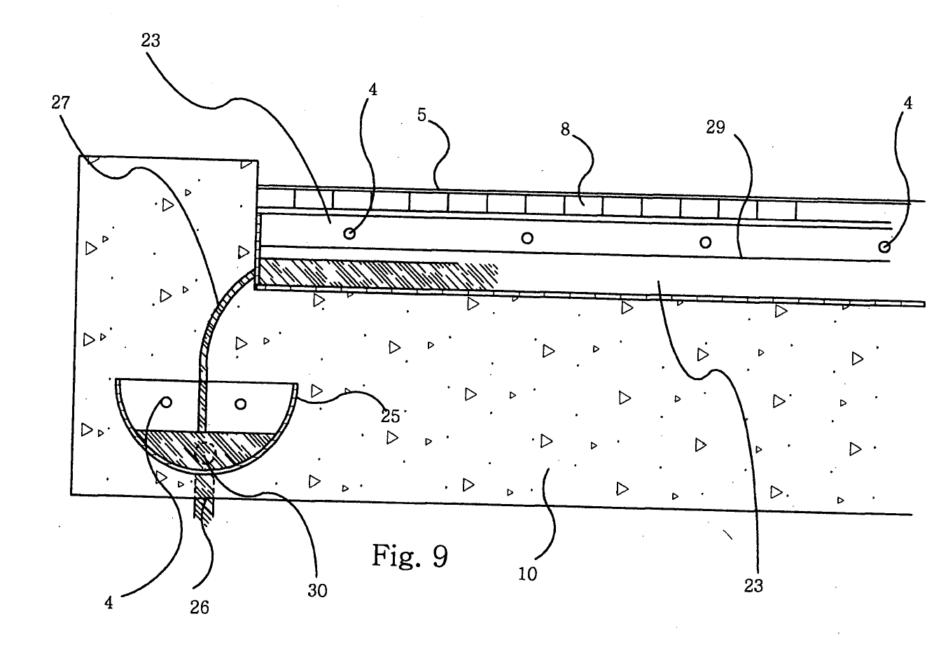

FIG. 8 is a cross sectional view of an embodiment of the invention wherein the weir wall of the pool is formed with a pre-existing notch so that a pre-assembled notch trough can be placed into the notch and anchored later by an anchor means. The pool weir wall (10) is poured into place and a notch (13) is excavated to anchor a prefabricated notch trough (23) into the notch (13) This notch trough is anchored by an anchor bolt means (2) placed into the pre-cored opening (3) A side wall trough sealing means (24) extends out on each side of the trough at an angle for a small distance to direct the overflow (27) properly into the half moon or clamshell catch basin (25) below. [See FIG. 9 for an elevational view of the overflow (27) being directed by this side wall trough sealing means into the catch basin (25)]. In the embodiment shown, the front leading edge (29) of the prefabricated notch trough (23) is high enough that the run-off must exit on each side of the trough. In this embodiment, the prefabricated notch trough (23) is anchored into the weir wall (10) during construction, and a prefabricated half moon or clamshell catch basin (25) is attached below the prefabricated notch trough (23). An epoxy and/or an acrylic adhesive or other waterproof adhesive means can also be used to also anchor the trough into the notch (13). In this embodiment, an anchor bolt means (2) and a pre-cored opening (3) are also shown helping to anchor the prefabricated notch trough (23) into the notch (13). the prefabricated notch trough (23) can be installed without, or with, a full, half, partial, or any size cap. In the embodiment shown, a partial cap (8) configuration was used. A side spout drainage catch basin (25) to catch side spout drainage (27) is also shown. In this embodiment, the catch basis drainage means (26) is pre-plumbed into the weir wall, and the gunite is poured around it. But it could be pre-fabricated and run along the outside of the wall (10). Also, it is understood that a plurality of notches could be pre-formed and/or excavated in the weir walls of the pool.

FIG. 9 is an elevational view of the embodiment of the invention shown in FIG. 8. The prefabricated notch trough (23) along one side of the weir wall (10) with a side spout drainage (27) falling into a half clamshell shaped basin (25) is shown. the heads of the anchor bolt sealing means (4) can be seen. The front leading edge (29) of the prefabricated notch trough (23) is also shown. the front opening (30) of the catch basis drainage means (26) is also visible.

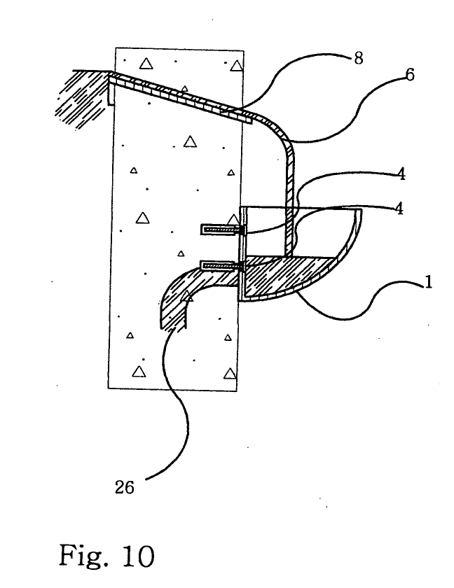

FIG. 10 is a cross sectional view of an alternative embodiment of the invention showing a trough (1) without any cap, which is set lower below the decorative overflow surface (8). In this particular embodiment, the prefabricated trough (1) has a half clam configuration. However it could be comprised of any suitable shape able to adequately catch the run off water.

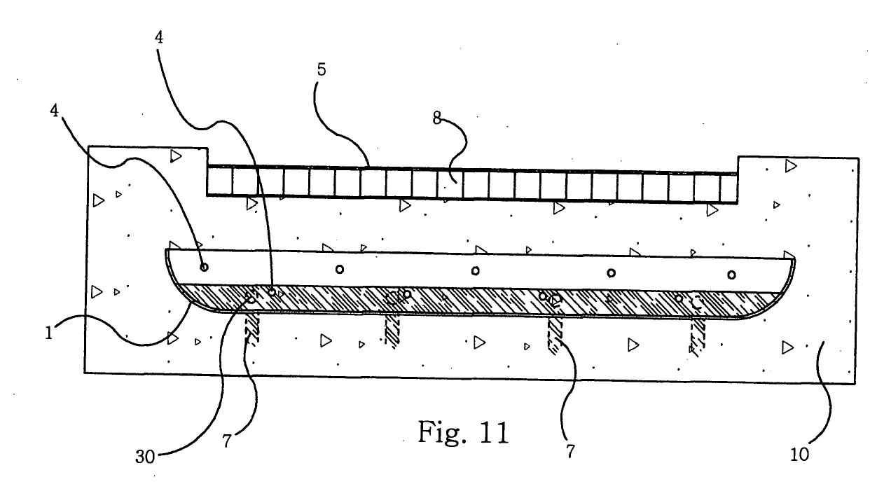

FIG. 11 is an elevational view of an embodiment of the invention drawn in FIG. 10 showing an embodiment of a trough (1) which is set below the decorative overflow surface (8), and in this particular embodiment, the prefabricated trough (1) has a curved configuration at the end of the trough. However it could be comprised of any suitable shape able to adequately catch the run off water. It also shows a plurality of drainage means (7) for the trough (1).

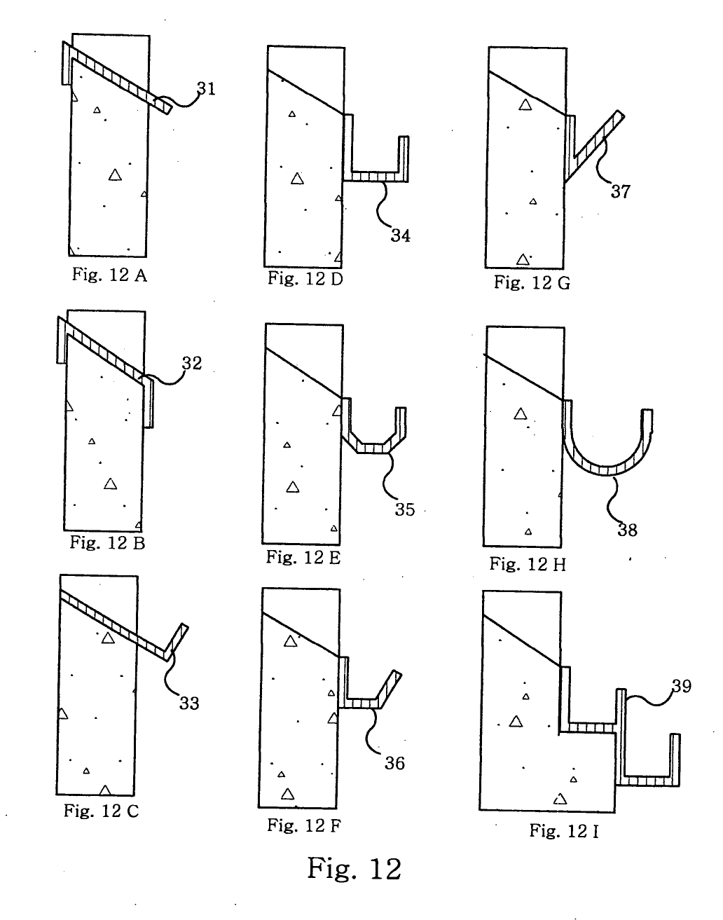

FIG. 12 shows a number of cross sectional views of possible prefabricated trough configurations which can be installed as the prefabricated trough means. FIG. 12a prefabricated ledge cap configuration with a straight drop off (31); FIG. 12b shows a prefabricated full cap configuration with a second vertical locking lip (32) on the outside of the weir wall (10); FIG. 12c is an embodiment with a prefabricated open ended L-cap configuration (33); FIG. 12d comprises a prefabricated square trough (34) which can be embodied with closed or open ends on the lateral edges of the trough; FIG. 12e shows a prefabricated C-square cap configuration (35); FIG. 12f displays a prefabricated forward trough configuration (36) which can be embodied with closed or open ends; FIG. 12g is a prefabricated V trough configuration (37) which can be embodied with closed or open ends; FIG. 12h is an embodiment with a prefabricated C-trough configuration (38) which can be embodied with closed or open ends; and FIG. 12i exhibits a prefabricated double trough configuration (39) which can be embodied with closed or open ends.

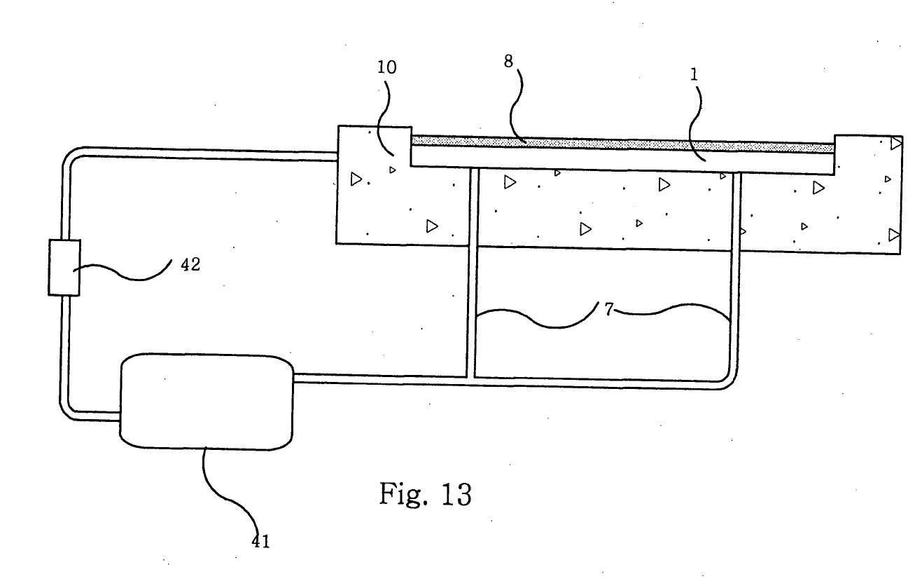

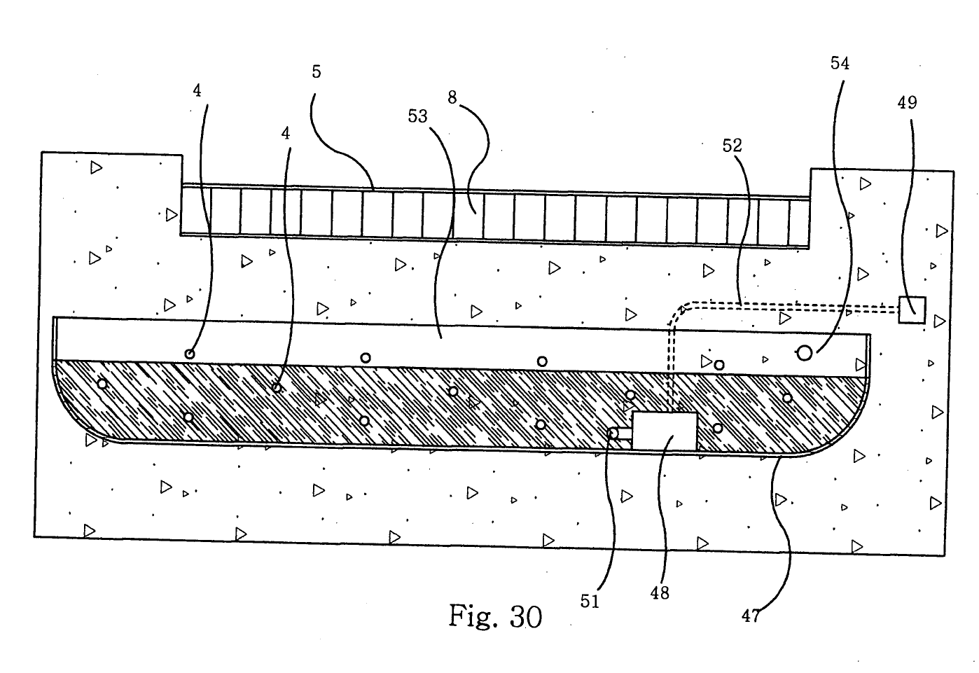

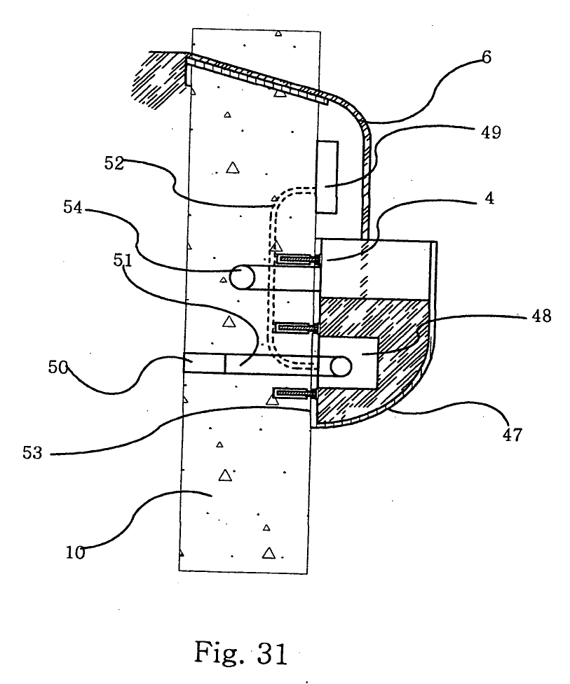

FIG. 13 is a schematic diagram illustrating the operation of a typical recirculation system in the preferred embodiment of the invention. The recirculating pump for the negative edge effect system (42) and reservoir means (41) are displayed. As with most pools, there is a reservoir means for collecting the output drainage from the trough, a pumping means for recirculating the drainage from the reservoir means from the trough back into the pool, and an input means to return the recirculated drainage from the reservoir means back into the pool. Although most negative edge effect pools have two separate systems, one embodiment of this invention allows the reservoir means to contain a filter system to filter all of the water in the pool so two separate filter systems are not required. This is because the multiple troughs can help to collect leaves and other detritus as it falls over the weir wall, thereby obviating a need for two separate pumping systems. Another embodiment of the invention is comprised of a trough with a pump recirculation system for the edge effect pre-fabricated and pre-installed in the trough itself as part of the pre-assembled trough (See FIGS. 30 and 31 below).

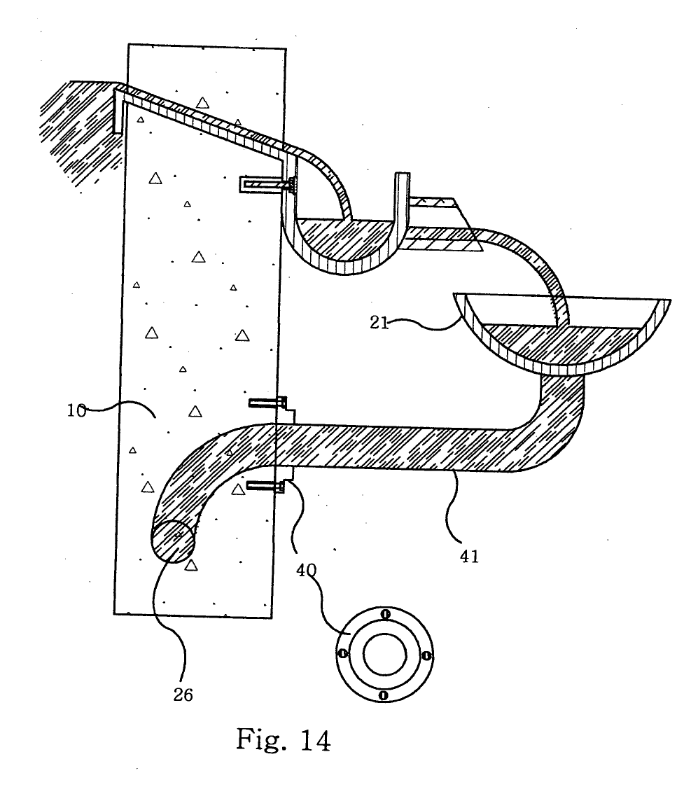

FIG. 14 is an exploded view of the invention showing a cross-section and an elevational view of a prefabricated inlet manifold (41) and a manifold anchoring collar means (40) to actually hold up the pre-fabricated catch basin (21) in place. This is an alternative method for anchoring a pre-fabricated catch basin.

FIG. 15 is a perspective view of an example of a prefabricated ridged textured weir wall surface cap which can be embodied as an alternative configuration of the invention. The cap does not have to simply serve a useful function. Different textured surface configurations can be used to in the pre-fabricated cap surface to create different water play as it spills over the weir wall.

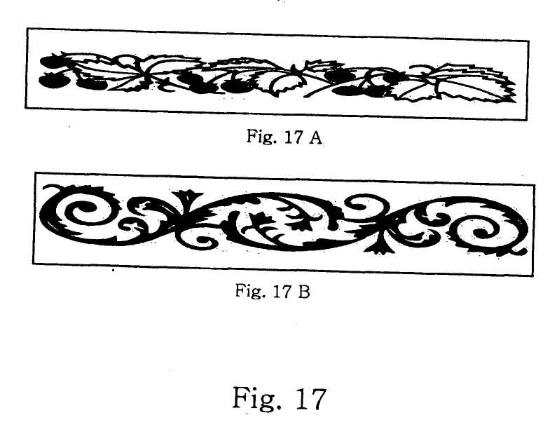

FIG. 16 is a perspective view of an example of a prefabricated scalloped textured weir wall surface cap which can be embodied as an alternative configuration of the invention. Different textured surface configurations can be used to in the pre-fabricated cap surface to create different water play as it spills over the weir wall.

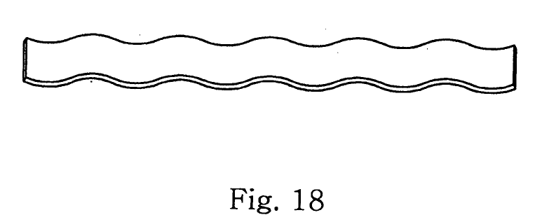

FIG. 17 shows two aerial views FIG. 17A and FIG. 17B of possible prefabricated designs embossed on a weir wall surface cap which can be embodied as an alternative configuration of the invention. Different design configurations can be used in the pre-fabricated cap surface to create different visual images as the water spills over the weir wall.

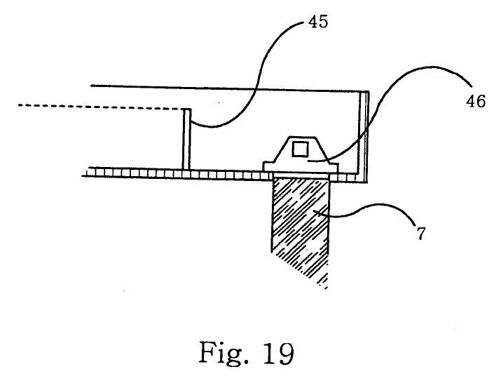

FIG. 18 is a perspective view of an example of a prefabricated wavelike textured weir wall surface cap which can be embodied as an alternative configuration of the invention. Again, different textured surface configurations can be used to in the pre-fabricated cap surface to create different water play as it spills over the weir wall.

FIG. 19 is a schematic diagram illustrating the location of an atrium drain (46) placed over a drain (7) in a trough (1) to catch sediment. The atrium drains can also be placed in various configurations in the troughs at various heights (45) in order to create varying water overflow effects by managing the water overflow more effectively or artistically.

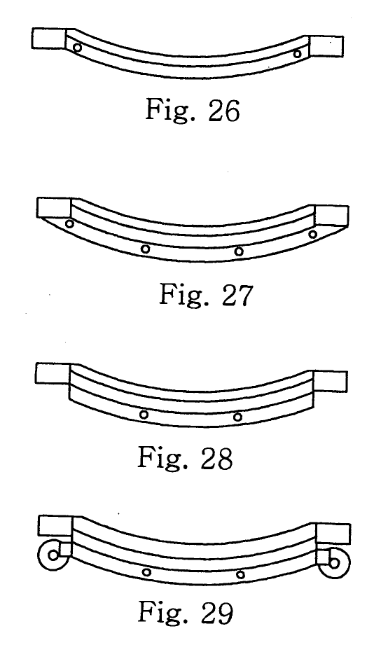

Many different shapes and sizes of pre-fabricated troughs and catch basins can be manufactured. FIGS. 20 through 29 show various examples of configurations which can be embodied in pre-fabricated troughs and catch basins that can be manufactured in advance and installed on the site so as to very quickly construct a negative edge effect pool.

FIG. 30 is an elevational view of the invention showing an embodiment of a trough with a pump recirculation system for the edge effect pre-fabricated and pre-installed in the trough itself as part of the pre-assembled trough. The trough is set below the decorative overflow surface (8), and is pre-fabricated with a submersible pump (48) being pre-assembled inside the trough. The submersible pump (48) has a pre-assembled supply line to return drainage to the pool (51) and a modified catch basin (47) with which to anchor the pump on. An electrical conduit (52) is run to the trough to allow electric power to the submersible pump (48). A junction box (49) can also be seen. (This is a waterproof box typically at least 12″ above the water line of the trough to provide power to the submersible pump, as well as pump controls and timer(s), etc.). An overflow prevention diverter drain (54) is visible and pre-installed to prevent overflow problems should the pump fail or be unable to adequately empty the trough as required by the amount of run off water going over the weir wall. In this embodiment, a back plate (53) which sticks up above the trough, making attachment to the weir wall easier. The water level (5), the bolt sealing means (4) and the cap (8) are also shown.

FIG. 31 is a cross sectional view of the invention also shown in FIG. 30. It shows the embodiment of a trough with a pump recirculation system for the edge effect pre-fabricated and pre-installed in the trough itself as part of the pre-assembled trough. The trough is visible set below the decorative overflow surface cap as is the submersible pump (48) which is pre-assembled inside the trough. The pre-assembled supply line to return drainage to the pool (51) and a modified catch basin (47) with which to anchor the pump on is also visible. The electrical conduit (52) running to the trough to allow electric power to the submersible pump (48) is shown, as is the junction box (49). The overflow prevention diverter drain (54) is visible, as is a back plate (53) which sticks up above the trough, making attachment to the weir wall easier. The back plate is a template which has borings matching the attachment means borings on the pre-assembled trough. The back plate can therefore be installed first as a template and anchor point. The pre-assembled trough can then be easily attached to the back plate which is already attached to the weir wall. The water level (5) and The bolt sealing means (4) are also shown from the side in this cross-section.

Although the pre-assembled trough comprises an apparatus used in the building of a negative edge effect pool, the use of this pre-assembled trough also constitutes a process for building a vanishing edge pool using steps which incorporate the installing the pre-assembled trough and utilizing it in the construction process itself.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A pre-fabricated device for creating a vanishing edge effect comprising:
a pool of water with a plurality of vertical walls to hold the water in at a specified depth at rest;
one of the walls being a weir wall;
a prefabricated trough;
an attachment means to anchor the prefabricated trough to the exterior side of the weir wall of the pool so as to catch the overflow of the pool as it pours over the weir wall;
a means of drainage for output from the prefabricated trough;
a reservoir means for collecting the output drainage from the prefabricated trough;
a pumping means for raising the water level in the pool by recirculating the drainage from the reservoir means from the trough back into the pool; and
an input means to return the recirculated drainage from the reservoir means back into the pool.

2. A device for creating a vanishing edge effect as claimed in claim 1 wherein there are a plurality of weir walls, each having a prefabricated trough to collect the overflow from the pool.

3. A device for creating a vanishing edge effect as claimed in claim 1 wherein a plurality of drainage means are built into the prefabricated trough.

4. A device for creating a vanishing edge effect as claimed in claim 1 wherein a plurality of prefabricated troughs are attached to one or more of the weir walls.

5. A device for creating a vanishing edge effect as claimed in claim 1 wherein the prefabricated trough contains a partial cap to cover part of the thickness of the top of the exterior weir wall which is lower than the specified level of water in the pool.

6. A device for creating a vanishing edge effect as claimed in claim 5 wherein a pre-constructed post anchor means is pre-attached to the bottom of the pre-assembled cap itself so as to help anchor the cap to the exterior wall.

7. A device for creating a vanishing edge effect as claimed in claim 1 wherein the prefabricated trough contains a half cap to cover one half of the thickness of the exterior weir wall.

8. A device for creating a vanishing edge effect as claimed in claim 1 wherein the prefabricated trough contains a full cap to cover the entire thickness of the exterior weir wall.

9. A device for creating a vanishing edge effect as claimed in claim 8 wherein the prefabricated trough full cap has a vertical lip to help anchor the prefabricated trough with a full cap onto the exterior weir wall.

10. A device for creating a vanishing edge effect as claimed in claim 1 wherein the drainage means for the prefabricated trough is comprised of a spout means to direct the overflow of water into a catch basin, the catch basin then directing the overflow of water into the reservoir means.

11. A device for creating a vanishing edge effect as claimed in claim 10 wherein the spout means and catch basin are built so as to serve a decorative as well as a useful function.

12. A device for creating a vanishing edge effect as claimed in claim 1 wherein the reservoir means contains a filter system to filter all of the water in the pool so two separate filter systems are not required.

13. A device for creating a vanishing edge effect as claimed in claim 1 wherein a pump recirculation system for the edge effect is pre-fabricated and pre-installed in the trough itself as part of the pre-assembled trough.

14. A device for creating a vanishing edge effect as claimed in claim 1 wherein a back plate is attached to the weir wall, thereby making attachment of the trough to the weir wall easier.

15. A process for constructing a vanishing edge effect comprising the steps of:
building a pool of water with a plurality of vertical walls to hold the water in at a specified depth wherein one wall of the pool is a weir wall;
building a prefabricated trough;
utilizing an attachment means to anchor the prefabricated trough to the exterior side of the weir wall of the pool so as to catch the overflow of the pool as it pours over the weir wall once it is installed and the level of water is raised;
installing a means of drainage for output from the prefabricated trough;
installing a reservoir means for collecting the output drainage from the prefabricated trough;
installing a pumping means for raising the water level in the pool by recirculating the drainage from the reservoir means from the trough back into the pool; and
installing an input means to return the recirculated drainage from the reservoir means back into the pool.

15. A process for constructing a vanishing edge effect as claimed in claim 15 wherein there are constructed a plurality of weir walls, each having a prefabricated trough to collect the overflow from the pool.

16. A process for constructing a vanishing edge effect as claimed in claim 15 wherein a plurality of drainage means are built into the prefabricated trough.

17. A process for constructing a vanishing edge effect as claimed in claim 15 wherein a plurality of troughs are attached to one or more of the weir walls.

18. A process for constructing a vanishing edge effect as claimed in claim 15 wherein the prefabricated trough contains a partial cap to cover part of the exterior weir wall.

19. A process for constructing a vanishing edge effect as claimed in claim 15 wherein the prefabricated trough contains a half cap to cover one half of the thickness of the exterior weir wall.

20. A process for constructing a vanishing edge effect as claimed in claim 15 wherein the prefabricated trough contains a full cap to cover the entire thickness of the exterior weir wall.

21. A process for constructing a vanishing edge effect as claimed in claim 20 wherein the prefabricated trough full cap has a vertical lip to help anchor a trough with a full cap onto the exterior weir wall.

22. A process for constructing a vanishing edge effect as claimed in claim 15 wherein the drainage means for the trough is constructed as a spout means to direct the overflow of water into a catch basin, the catch basin then directing the overflow of water into the reservoir means.

23. A process for constructing a vanishing edge effect as claimed in claim 15 wherein the weir wall of the pool is formed with a pre-existing notch so that a pre-assembled notch trough can be placed into the notch and anchored later by an anchor means.

24. A process for constructing a vanishing edge effect as claimed in claim 23 wherein a plurality of notches are pre-formed in the weir walls of the pool.

25. A process for constructing a vanishing edge effect as claimed in claim 15 wherein a pump recirculation system for the edge effect is pre-fabricated and pre-installed in the trough itself as part of the pre-assembled trough.

26. A process for constructing a vanishing edge effect as claimed in claim 15 wherein a back plate is attached to the weir wall first, thereby making attachment of the trough to the weir wall easier.
